(19) United States
(12) Patent Application Publication
(10) Pub. No.: US 2026/0189522 A1
(43) Pub. Date: Jul. 2, 2026

(54) Method and Apparatus for Operating a Digital Assistant of a Vehicle

(71) Applicant: Bayerische Motoren Werke Aktiengesellschaft, Muenchen (DE)

(72) Inventor: Mathias Ordung, Muenchen (DE)

(21) Appl. No.: 19/128,485

(22) PCT Filed: Aug. 8, 2023
(86) PCT No.: PCT/EP2023/071942

§ 371 Date: May 8, 2025

(30) Foreign Application Priority Data
Nov. 22, 2022 (DE) 10 2022 130 792.1

(51) Int. Cl. H04L 51/02; H04L 51/046

(52) U.S. Cl. CPC H04L 51/02; H04L 51/046

(57) ABSTRACT

Operating a digital assistant of a vehicle includes detecting a trigger event of a cloud-based dialog control application of the digital assistant of the vehicle using the vehicle. The method also includes transmitting the trigger event of the cloud-based dialog control application of the digital assistant of the vehicle from the vehicle to a cloud-based server. The method further includes receiving a response message of the cloud-based dialog control application of the digital assistant of the vehicle from the cloud-based server using the vehicle, and determining an output decision for the response message of the cloud-based dialog control application of the digital assistant of the vehicle using the vehicle. The method also includes providing the response message of the cloud-based dialog control application of the digital assistant of the vehicle by means of an output device of the vehicle based at least in part on the determined output decision.

The present application is the U.S. national phase of PCT Application PCT/EP2023/070446 filed on Jul. 24, 2023, which claims priority of German patent application No. 10 2022 131 041.8 filed on Nov. 23, 2022, the entire contents of which are incorporated herein by reference.

### TECHNICAL FIELD

The present disclosure relates generally to vehicles, and more particularly, to methods and apparatus for operating a digital assistant of a vehicle.

### BACKGROUND

Digital assistants in vehicles must often be actively called by a user of the vehicle using a keyword in order to enable a dialog. Proactive provision of a dialog by digital assistants is not provided. The dialog is controlled exclusively in the vehicle in order to keep delays in the dialog control short and therefore to prevent the driver from being distracted. This leads to restrictions in use of digital assistants in the vehicle.

There is a need, therefore, for a way to efficiently prevent the driver from being distracted in the case of a cloud-based dialog control application of a digital assistant of the vehicle. There is furthermore a need to provide a user of the vehicle with proactive messages from a cloud-based dialog control application in an efficient manner, and in particular while preventing the driver of the vehicle from being distracted, during a journey with the vehicle.

### SUMMARY

One or more of the above-discussed needs, as well as others, are addressed by at least some embodiments disclosed herein.

A first aspect is a method for operating a digital assistant of a vehicle. The method may be a computer-implemented method and/or a control-device-implemented method. The digital assistant may be a dialog-based, digital assistant of the vehicle. The digital assistant may be operated in a voice-based, gesture-based and/or d: touch-based manner. The method comprises detecting a trigger event of a cloud-based dialog control application of the digital assistant of the vehicle by means of the vehicle. The trigger event may be determined by the vehicle on the basis of a driving parameter of the vehicle. For example, the trigger event may be exceeding of a speed limit by a predefined value and/or outputting of a warning message to a driver of the vehicle by means of a driver assistance system when the speed limit is exceeded during a journey with the vehicle.

The method also comprises transmitting the trigger event of the cloud-based dialog control application of the digital assistant of the vehicle from the vehicle to a cloud-based server. The cloud-based server may execute the cloud-based dialog control application. The trigger event is preferably transmitted to the cloud-based server via a communication interface of the vehicle, for example a mobile radio communication interface of the vehicle. The method also comprises receiving a response message of the cloud-based dialog control application of the digital assistant of the vehicle from the cloud-based server by means of the vehicle, determining an output decision for the response message of the cloud-based dialog control application of the digital assistant of the vehicle by means of the vehicle, and providing the response message of the cloud-based dialog control application of the digital assistant of the vehicle by means of an output device of the vehicle on the basis of the determined output decision.

The method can advantageously efficiently prevent or at least reduce distraction of a driver of the vehicle during the journey with the vehicle. The decision as to whether the response message of the cloud-based dialog control application provided in the vehicle is made by the vehicle. The of the cloud-based dialog control application can be executed without accurate knowledge of a current situation in the vehicle and can proactively transmit the response message to the vehicle. Delays which may arise when transmitting the trigger result from the vehicle to the cloud-based server, when processing the trigger event by means of the cloud-based dialog control application and/or when receiving the response message of the cloud-based dialog control application do not affect possible distraction of the driver since the decision to provide the response message is made by the vehicle. The method can therefore proactively provide the driver of the vehicle with messages efficiently and without distracting the driver during a journey with the vehicle. The preferably proactive provision of the message, in particular the response message, of the cloud-based dialog control application to the driver of the vehicle can therefore be efficiently decoupled by the method from transmission and processing of the trigger result and/or transmission and reception of the response message.

According to one exemplary configuration, the trigger event may be a trigger event of a proactive dialog of the cloud-based dialog control application of the digital assistant of the vehicle. The method can hereby efficiently provide the driver of the vehicle with proactive dialogs.

According to a further exemplary configuration, the response message of the cloud-based dialog control application may comprise a dialog control element of the proactive dialog of the cloud-based dialog control application of the digital assistant of the vehicle, and/or the output decision for the response message of the cloud-based dialog control application of the digital assistant of the vehicle by the vehicle may comprise an output decision of the dialog control element of the proactive dialog of cloud-based dialog control the application of the digital assistant of the vehicle, and/or the provision of the response message of the cloud-based dialog control application of the digital assistant of the vehicle may comprise providing the dialog control element of the proactive dialog of the cloud-based dialog control application of the digital assistant of the vehicle by means of the output device of the vehicle on the basis of the determined output decision. This makes it possible to efficiently provide the driver of the vehicle with a dialog control element of a proactive dialog.

According to some embodiments, the dialog control element may be a voice-based dialog control element, a visual dialog control element, an audiovisual dialog control element, and/or the dialog control element may comprise a combination of two or more of these dialog control elements. This makes it possible to efficiently provide the driver of the vehicle with the dialog control element via various output devices of the vehicle.

According to some embodiments, the method may also comprise adding the response message of the cloud-based dialog control application of the digital assistant of the vehicle to a message queue for response messages of the cloud-based dialog control application by means of the vehicle, determining a length of the message queue for a predefined vehicle-specific time interval and/or a user-specific time interval by means of the vehicle, and determining the output decision for the response message of the cloud-based dialog control application of the digital assistant of the vehicle by means of the vehicle on the basis of the of length the message queue determined by means of the vehicle. This makes it possible to efficiently determine the output decision on the basis of a number and/or frequency of response messages.

According to some implementations, the output decision for the response message the cloud-based dialog control application of the digital assistant of the vehicle may be determined by the vehicle on the basis of a vehicle-specific, rule-based context. This makes it possible to efficiently determine the output decision in a context-based manner.

According to some embodiments, the output decision for the response message of the cloud-based dialog control application of the digital assistant of the vehicle may be determined by the vehicle on the basis of a vehicle situation-specific and/or a driving situation-specific context. This makes it possible to efficiently determine the output decision in a context-based manner.

According to some configurations, the method may comprise receiving a predefined interruptibility threshold value of a currently performed vehicle function, and determining an interruptibility of the currently performed vehicle function, wherein the interruptibility of the currently performed vehicle function is determined on the basis of a vehicle situation-specific context and/or a driving situation-specific context and the predefined interruptibility threshold value of the currently performed vehicle function. Furthermore, the method may determine the output decision for the response message of the cloud-based dialog control application of the digital assistant of the vehicle by the vehicle on the basis the determined interruptibility of the currently performed vehicle function. This makes it possible to provide the response message efficiently and without distracting the driver.

According to some implementations, the method may comprise receiving a predefined interruptibility threshold value of a currently vehicle performed function, and determining an interruptibility of the currently performed vehicle function on the basis of a priority of the response message of the cloud-based dialog control application of the digital assistant of the vehicle and the received predefined interruptibility threshold value of the currently performed vehicle function. Furthermore, the method may determine the output decision for the response message of the cloud-based dialog control application of the digital assistant of the vehicle by the vehicle from the determined interruptibility of the currently performed vehicle function. This makes it possible to provide the response message efficiently and without distracting the driver.

According to some embodiments, the output decision for the response message of the cloud-based dialog control application of the digital assistant of the vehicle may be determined by the vehicle on the basis of a driver-specific context, and the driver-specific context may preferably comprise an emotional state of the driver, a driver-specific driving behavior and/or a driver-specific preference with regard to provision of a proactive dialog control element by the vehicle. This makes it possible to provide the response message efficiently and without distracting the driver.

According to some implementations, the interruptibility of the currently performed vehicle function may be determined on the basis of a priority of the response message of the cloud-based dialog control application of the digital assistant of the vehicle and a driver-specific interruptibility threshold value, and the driver-specific interruptibility threshold value may be determined on the basis of a driver-specific preference with regard to provision of a proactive dialog control element by the vehicle. This makes it possible to provide the response message efficiently and without distracting the driver.

A further aspect is a computer-readable medium for operating a digital assistant of a vehicle, wherein the computer-readable medium comprises instructions which, when executed on a computer or a control device, carry out one or more of the methods described above.

A further aspect is a system for operating a digital assistant of a vehicle, wherein the system is designed to carry out one or more of the methods described above.

A further aspect is a vehicle comprising the system described above for operating a digital assistant of a vehicle.

Further features emerge from the claims, the FIGURE and the description of the FIGURE. All features and combinations of features mentioned above in the description and the features and combinations of features mentioned below in the description of the FIGURE and/or shown in the FIGURE alone can be used not only in the respectively stated combination, but also in other combinations or alone.

### BRIEF DESCRIPTION OF THE DRAWING FIGURE

FIG. 1 schematically shows an exemplary method for operating a digital assistant of a vehicle.

### DETAILED DESCRIPTION

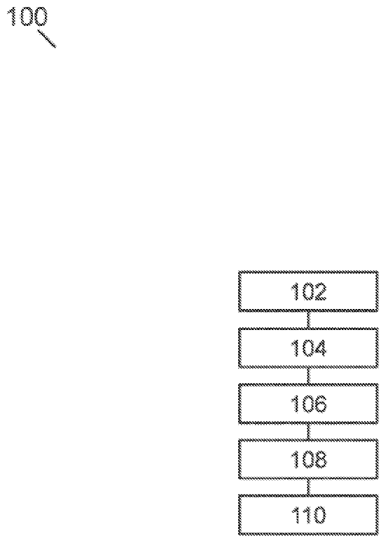

In detail, FIG. 1 shows an exemplary method 100 for operating a digital assistant of a vehicle. The method may detect 102 a trigger event of a cloud-based dialog control application of the digital assistant of the vehicle by means of the vehicle. The trigger result may be detected on the basis of sensor data from one or more sensors of the vehicle. For example, the trigger event may exceeding of a speed limit by a speed threshold value, which is predefined or is specified by a user, during a journey with the vehicle, and/or output of a warning message to a driver of the vehicle with respect to exceeding of a speed limit by a speed threshold value, which is predefined or is specified by a user, during the journey with the vehicle.

The method 100 may transmit 104 the trigger event of the cloud-based dialog control application of the digital assistant of the vehicle from the vehicle to a cloud-based server. The cloud-based server may be a server of a cloud computing system that is outside the vehicle and is communicatively coupled via a to the vehicle communication channel. The method preferably transmits 104 the trigger event from the vehicle to the cloud-based server via a wireless communication channel. For example, the method 100 may transmit the exceeding of the speed limit by a speed threshold value, which is predefined or is specified by a user, during the journey with the vehicle from the vehicle to the cloud-based server as a trigger event.

The method 100 may receive 106 a response message of the cloud-based dialog control application of the digital assistant of the vehicle from the cloud-based server by means of the vehicle. The response message may be a message of the cloud-based dialog control application of the digital assistant of the vehicle in response to the trigger event of the vehicle. The trigger event is preferably a proactive trigger event. In other words, in order to detect the trigger event, in particular the proactive trigger event, there is no need for a voice command, for example an activation word from the digital assistant, and/or any other further voice commands or any other explicit operating interaction between the driver of the vehicle and the digital assistant of the vehicle during the journey with the vehicle. For example, the method may receive a response message in response to the exceeding of the speed limit by a speed threshold value, which is predefined or is specified by a user, during the journey with the vehicle as a trigger event. In the example of exceeding the speed, the response message may comprise a voice message and/or a text message that can be output in a pop-up window of a display device of the vehicle. For example, the response message may comprise a recommendation to temporarily deactivate display of a warning message when the speed limit is exceeded. Additionally or alternatively, the response message may comprise an operating request, in the case of which the display of a warning message when the speed limit is exceeded can be temporarily deactivated. Additionally or alternatively, the message may comprise an operating request that is used to stipulate a new trigger event of the assistant digital for temporarily deactivating the display of the warning message when the speed limit is exceeded. For example, the new trigger event may specify that, each time the digital assistant is started, the driver of the vehicle is provided with the operating request to temporarily deactivate the display of the warning message when the speed limit is exceeded.

The response message can be received from the cloud-based server by the vehicle with a delay. A round-trip time of the communication channel, in particular the wireless communication channel, between the vehicle and the cloud-based server may vary, such that there may be a delay between the detection of the trigger event by the vehicle and the reception of the response message in response to the trigger event from the cloud-based server by the vehicle.

The method 100 may determine 108 an output decision for the response message of the cloud-based dialog control application of the digital assistant of the vehicle by means of the vehicle. After the vehicle has received the response message, the method 100 may determine 108 whether a driver of the vehicle is intended to be provided with the response message. The method 100 may determine an output decision for this purpose. The output decision may be determined by the vehicle in a rule-based and/or context-based manner. The output decision for the response message be determined on the basis of the following exemplary criteria and/or rules:
availability of one or more output devices in the vehicle,
permission of a user of the vehicle, in particular the driver of the vehicle, to provide and/or output proactive messages, in particular proactive response messages, present,
no active telephone call,
no interaction between the driver of the vehicle and an operating interface of the vehicle within a predefined period of time, for example within the last 1, 2, 3, 4, 5 seconds,
maximum number of provided messages, in particular provided response messages of one or more cloud-based dialog control applications of the digital assistant of the vehicle, reached or not yet reached, and/or
minimum interval of time between two messages, in particular between two provided response messages of one or more cloud-based dialog control applications of the digital assistant of the vehicle, exceeded or undershot.

Additionally or alternatively, the method 100 may determine the output decision on the basis of a context. The context may be a rule-based context. Additionally or alternatively, the context may be a rule-based, driver-specific context. For example, a context may be a vehicle situation-based context or a driving situation-based context. The vehicle situation-based context may be representative of use of a driver assistance function and/or a vehicle status. The driving situation-based context may be representative of driving dynamics and/or an environment of the vehicle.

In addition to the context, the method may determine an interruptibility threshold value for a vehicle function and may determine the output decision on the basis of the context and the interruptibility threshold value of the vehicle function. The interruptibility threshold value may be representative of a minimum priority of the response message that must be complied with so that the vehicle function is interrupted or paused and the response displayed to the driver during the journey. If a priority of the response message exceeds the interruptibility threshold value of the vehicle function, the method may determine a positive output decision to provide the driver with the response message.

In the example of exceeding the speed limit during a journey with the vehicle, the method may determine the output decision by way of example as follows: the method may check whether the speed limit is still exceeded by the driver or whether the driver has reduced the speed by braking. If the driver has reduced the speed, the method may determine an output decision that prevents the driver of the vehicle from being provided with the response message.

Finally, the method 100 may provide 110 the response message of the cloud-based dialog control application of the digital assistant of the vehicle by means of an output device of the vehicle on the basis of the determined output decision. The driver of the vehicle may or may not be provided with the response message. The provision may comprise transmitting a status message relating to effected provision of the response message or non-effected provision of the response message by the vehicle to the cloud-based dialog control application of the digital assistant of the vehicle on the cloud-based server.

The method can advantageously efficiently link a cloud-based dialog control application, which executed outside the vehicle on a cloud-based server, to the digital assistant of the vehicle without the driver of the vehicle being distracted by proactive messages of the cloud-based dialog control application. Determining an output decision that takes into account a current context of the vehicle and of the driver of the vehicle makes it possible to efficiently allow or prevent provision of a proactive message a cloud-based dialog control application to the driver of the vehicle, depending on whether or not distraction of the driver by the output of the message can be expected in a context-based manner. The digital assistant of the vehicle can therefore operated more safely.

List of reference signs

| | |
|---|---|
| 100 | Method |
| 102 | Detection of a trigger event |
| 104 | Transmission of the trigger event |
| 106 | Reception of a response message |
| 108 | Determination of an output decision |
| 110 | Provision of the response message |

1.-14. (canceled)

15. A method for operating a digital assistant of a vehicle, the method comprising:
detecting a trigger event of a cloud-based dialog control application of the digital assistant of the vehicle using the vehicle;
transmitting the trigger event of the cloud-based dialog control application of the digital assistant of the vehicle from the vehicle to a cloud-based server;
receiving a response message of the cloud-based dialog control application of the digital assistant of the vehicle from the cloud-based server using the vehicle;
determining an output decision for the response message of the cloud-based dialog control application of the digital assistant of the vehicle using the vehicle; and
providing the response message of the cloud-based dialog control application of the digital assistant of the vehicle by means of an output device of the vehicle based at least in part on the determined output decision.

16. The method as claimed in claim 15, wherein the trigger event is a trigger event of a proactive dialog of the cloud-based dialog control application of the digital assistant of the vehicle.

17. The method as claimed in claim 15, wherein the response message of the cloud-based dialog control application comprises a dialog control element of a proactive dialog of the cloud-based dialog control application of the digital assistant of the vehicle.

18. The method as claimed in claim 17, wherein the dialog control element is a voice-based dialog control element, a visual dialog control element, an audiovisual dialog control element, or a combination of two or more of these dialog control elements.

19. The method as claimed in claim 18, wherein the output decision for the response message of the cloud-based dialog control application of the digital assistant of the vehicle by the vehicle comprises an output decision of the dialog control element of the proactive dialog of the cloud-based dialog control application of the digital assistant of the vehicle.

20. The method as claimed in claim 19, wherein providing the response message of the cloud-based dialog control application of the digital assistant of the vehicle comprises providing the dialog control element of the proactive dialog of the cloud-based dialog control application of the digital assistant of the vehicle using the output device of the vehicle based at least in part on the determined output decision.

21. The method as claimed in claim 20, wherein the dialog control element is a voice-based dialog control element, a visual dialog control element, an audiovisual dialog control element, or a combination of two or more of these dialog control elements.

22. The method as claimed in claim 15, wherein providing the response message of the cloud-based dialog control application of the digital assistant of the vehicle comprises providing a dialog control element of a proactive dialog of the cloud-based dialog control application of the digital assistant of the vehicle using the output device of the vehicle based at least in part on the determined output decision.

23. The method as claimed in claim 15, further comprising:
adding the response message of the cloud-based dialog control application of the digital assistant of the vehicle to a message queue for response messages of the cloud-based dialog control application using the vehicle;
determining a length of the message queue for a predefined vehicle-specific time interval using the vehicle; and
determining the output decision for the response message of the cloud-based dialog control application of the digital assistant of the vehicle using the vehicle based at least in part on the length of the message queue determined using the vehicle.

24. The method as claimed in claim 15, further comprising:
adding the response message of the cloud-based dialog control application of the digital assistant of the vehicle to a message queue for response messages of the cloud-based dialog control application using the vehicle;
determining a length of the message queue for a user-specific time interval using the vehicle; and
determining the output decision for the response message of the cloud-based dialog control application of the digital assistant of the vehicle using the vehicle based at least in part on the length of the message queue determined using the vehicle.

25. The method as claimed in claim 15, wherein the output decision for the response message of the cloud-based dialog control application of the digital assistant of the vehicle is determined by the vehicle based at least in part on a vehicle-specific, rule-based context.

26. The method as claimed in claim 15, wherein the output decision for the response message of the cloud-based dialog control application of the digital assistant of the vehicle is determined by the vehicle based at least in part on a situation-specific context, wherein the situation-specific context is at least one of the group consisting of a vehicle situation-specific context and a driving situation-specific context.

27. The method as claimed in claim 15, further comprising:
receiving a predefined interruptibility threshold value of a currently performed vehicle function;
determining an interruptibility of the currently performed vehicle function, wherein the interruptibility of the currently performed vehicle function is determined based at least in part on a situation-specific context, wherein the situation-specific context is at least one of the group consisting of a vehicle situation-specific context and a driving situation-specific context; and
wherein the output decision for the response message of the cloud-based dialog control application of the digital assistant of the vehicle is determined by the vehicle based at least in part on the determined interruptibility of the currently performed vehicle function.

28. The method as claimed in claim 15, further comprising:
receiving a predefined interruptibility threshold value of a currently performed vehicle function; and
determining an interruptibility of the currently performed vehicle function based at least in part on a priority of the response message of the cloud-based dialog control application of the digital assistant of the vehicle and the received predefined interruptibility threshold value of the currently performed vehicle function, and
wherein the output decision for the response message of the cloud-based dialog control application of the digital assistant of the vehicle is determined by the vehicle from the determined interruptibility of the currently performed vehicle function.

29. The method as claimed in claim 28, wherein the interruptibility of the currently performed vehicle function is determined based at least in part on a priority of the response message of the cloud-based dialog control application of the digital assistant of the vehicle and a driver-specific interruptibility threshold value; and
wherein the driver-specific interruptibility threshold value is determined based at least in part on a driver-specific preference with regard to provision of a proactive dialog control element by the vehicle.

30. The method as claimed in claim 15, wherein the output decision for the response message of the cloud-based dialog control application of the digital assistant of the vehicle is determined by the vehicle based at least in part on a driver-specific context.

31. The method as claimed in claim 30, wherein the driver-specific context is at least one of the group consisting of: an emotional state of a driver, a driver-specific driving behavior, and a driver-specific preference with regard to provision of a proactive dialog control element by the vehicle.

32. A non-transitory computer-readable medium for operating a digital assistant of a vehicle, wherein the computer-readable medium comprises instructions which, when executed on a computer, carry out the method as claimed in claim 15.

33. A system for operating a digital assistant of a vehicle, wherein the system is designed to carry out the method as claimed in claim 15.

34. A vehicle comprising the system for operating a digital assistant of a vehicle as claimed in claim 33.
